(19) United States
(12) Patent Application Publication
(10) Pub. No.: US 2014/0308026 A1
(43) Pub. Date: Oct. 16, 2014

(54) DELAY CIRCUIT AND ELECTRONIC DEVICE USING THE SAME

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: YA-GUO WANG, Shenzhen (CN); CHUN-CHING CHEN, New Taipei (TW)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/059,995

(22) Filed: Oct. 22, 2013

(30) Foreign Application Priority Data
Apr. 16, 2013 (CN) 2013101305869

(51) Int. Cl. G11B 19/04

(52) U.S. Cl. CPC G11B 19/047
USPC 386/277

(57) ABSTRACT

An electronic device powered by a power supply is capable of playing video files. The electronic device includes a processor, a delay circuit, and a storage. The delay circuit disconnects the processor with the power supply, and outputs a record signal and a working voltage. The processor is powered on by the working voltage and records a current position of a playing video file in the storage in response to the record signal. The delay circuit further stops outputting the working voltage after a predetermined interval.

### BACKGROUND

1. Technical Field

The present disclosure relates to an electronic device with a delay circuit.

2. Description of Related Art

A DVD player for playing disc provides a function for recording a position to replay the disc from the recording position. The DVD player includes a processor for executing different functions in response to different instructions. When receiving a power-off instruction, the processor delays executing the power-off instruction for a predetermined time and record the location or position the disc was last read, such that the DVD player can play the disc from the recorded position the next time the disc is being played. However, the delay function is executed by the processor, if a program error occur in the processor, thus the recorded position may be missed or never recorded.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the electronic device and energy efficiency indicating method thereof Moreover, in the drawings, like reference numerals designate corresponding parts throughout the several views.

FIG. 1 is a block diagram of an electronic device in accordance with an embodiment.

FIG. 2 is a circuit diagram of the electronic device of FIG. 1 in accordance with one embodiment.

### DETAILED DESCRIPTION

In general, the word “module,” as used herein, refers to logic embodied in hardware or firmware, or to a collection of software instructions, written in a programming language, for example, Java, C, or assembly. One or more software instructions in the modules may be embedded in firmware, such as in an EPROM. Modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage system. Embodiments of the present disclosure will be described with reference to the drawings.

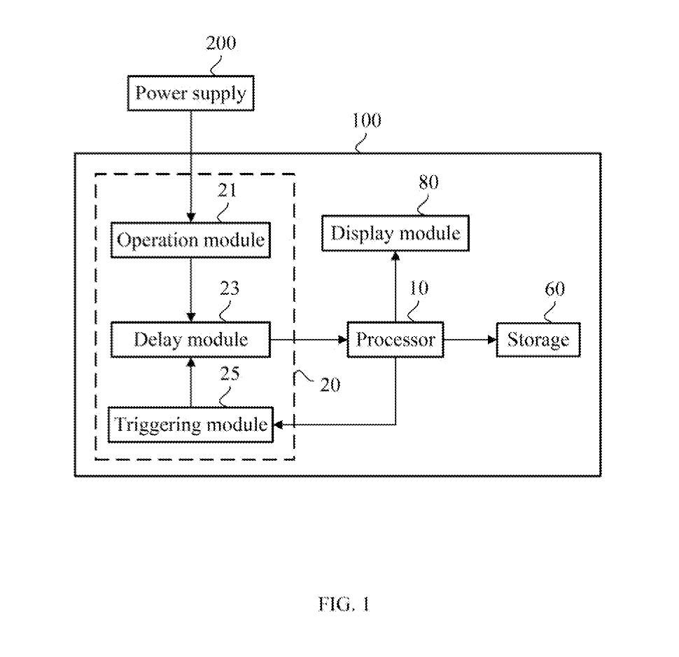

FIG. 1 shows an electronic device 100 of an embodiment. The electronic device 100 powered by a power supply 200 is capable of playing video files and delays the execution of a power-off instruction for a predetermined interval. In the embodiment, the electronic device 10 is a DVD player. In other embodiments, the electronic device 10 can be a computer, for example.

The electronic device 100 includes a processor 10, a delay circuit 20, a storage 60, and a display module 80.

The processor 10 connects between the delay circuit 20 and the storage 60. The processor 10 is capable of executing different functions.

The delay circuit 20 comprises an operation module 21, a delay module 23.

The operation module 21 is connected between the power supply 200 and the delay module 23. The operation module 21 establishes a connection between the power supply 200 and the delay module 23 if not receiving a power-off instruction, thus the voltage of the power supply 200 powers the processor 10. The operation module 21 further cuts off the connection between the power supply 200 and the delay module 23, and generates a record signal when receiving the power-off instruction. In the embodiment, the power-off instruction is generated by pressing a key.

The delay module 23 outputs a working voltage to the processor 10 when the operation unit 21 cuts off the connection between the power supply 200 and the delay module 23, and further stops outputting the working voltage after the predetermined interval.

The processor 10 is powered by the working voltage and executes a recording function for recording a current position of the playing video file in the storage 60 in response to the record signal, and further executes a power-off function if not receiving the voltage from the power supply 200 or the working voltage from the delay circuit 30.

The storage 60 stores the current position of the playing video file. In the embodiment, the storage 60 is an electrically erasable programmable read-only memory (EEPROM).

The display module 80 connects with the processor 10, and includes a number of parameters. In the embodiments, the parameters include brightness and resolution ratio of the playing video, for example.

The processor 10 further records the parameters of the display module 80 in the storage 60 in response to the record signal.

The delay circuit 20 further includes a triggering module 25. The triggering module 25 connects between the delay circuit 30 and the processor 10. The processor 10 further generates a triggering signal when the recording function is completed. The triggering module 25 controls the delay module 23 to stop outputting the working voltage in response to the triggering signal. In the embodiment, the triggering signal is a logic high level signal.

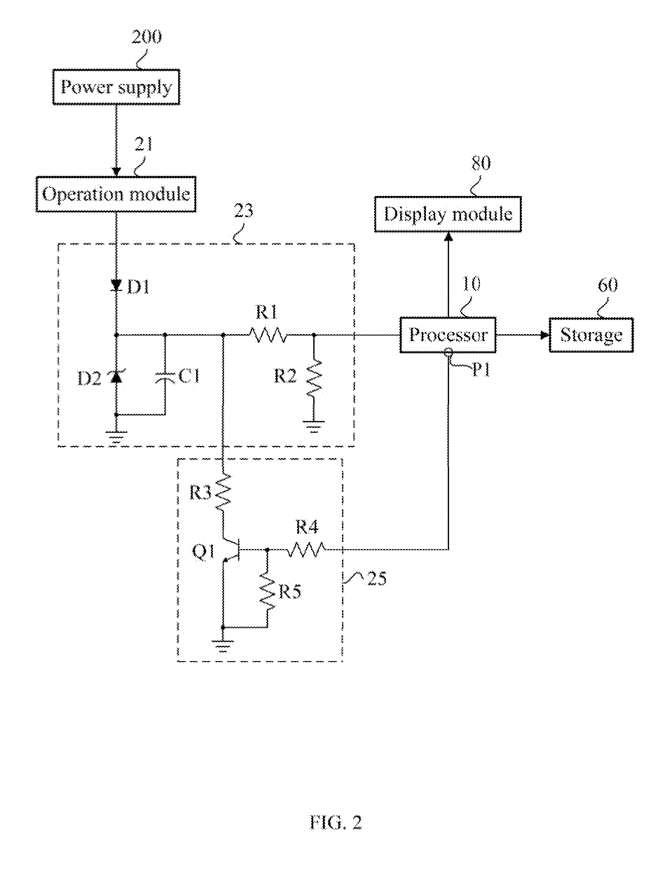

FIG. 2 shows that the processor 10 includes a first pin P1. The first pin P1 is connected to the triggering module 25. The delay module 23 includes a first diode D1, a second diode D2, a capacitor C1, a first resistor R1, and a second resistor R2. An anode of the first diode D1 is connected to the operation module 21. A cathode of the first diode D1 is connected to the processor 10 through the first resistor R1. An anode of the second diode D2 is grounded. A cathode of the second diode D2 is connected to the cathode of the first diode D1. A terminal of the capacitor C1 is connected to the cathode of the first diode D1. An opposite terminal of the capacitor C1 is grounded. A terminal of the second resistor R2 is connected to the cathode of the first diode D1. An opposite terminal of the second resistor R2 is grounded. In the embodiment, the capacitance of the capacitor C1 is adjustable or the resistance of the first resistor R1 and the second resistor R2 are adjustable.

The triggering module 25 includes a transistor Q1, a third resistor R3, a fourth resistor R4, and a fifth resistor R5. A base of the transistor Q1 is connected to the processor 10 through the fourth resistor R4. An emitter of the transistor Q1 is grounded. A collector of the transistor Q1 is connected to the cathode of the first diode D1 through the third resistor R3. Opposite terminals of the fifth resistor are respectively connected to the base of the transistor Q1 and the ground. In the embodiment, the transistor is an npn type bipolar junction transistor.

The working principle of the electronic device 100 is described as below, if not receiving the power-off instruction, the operation module 21 outputs the voltage of power supply 200. The voltage provided by the power supply 200 charges the capacitor C1. The voltage provided by the power supply 200 powers the processor 10.

When receiving the power-off instruction, the operation module 21 outputs the record signal to the processor 10. The capacitor C1 discharges through the first resistor R1 and the second resistor R2 to output a working voltage to the processor 10. The predetermined interval is calculated by the following equation: T=C1*(R1+R2). The processor 10 is powered by the working voltage and records the current position of the playing video file to store in the storage 60. When the processor 10 finishes the storing process, the first pin P1 outputs a logic high level signal. The voltage difference between the base and the emitter of the transistor Q1 is more than 0V, the transistor Q1 turns on. The capacitor C1 discharges through the first resistor R1, the second resistor R2, and the third resistor R3 for speeding up the discharging process of the first capacitor C1.

In use, the electronic device 100 executes the delay function through hardware elements and generates a triggering signal to end the delay function before the predetermined time arrives. Therefore, the efficiency of the delay function of the electronic device 100 is improved.

While various exemplary embodiments have been described, the disclosure is not to be limited thereto. Various modifications and similar arrangements (as would be apparent to those skilled in the art) are also intended to be covered. Therefore, the scope of the appended claims should be accorded the broadest interpretation so as to encompass all such modifications and similar arrangements.

What is claimed is:

1. An electronic device powered by a power supply capable of playing video files, the electronic device comprising:
a processor powered by the power supply;
a delay circuit connected between the power supply and the processor; and
a storage connected to the processor;
wherein when receiving a power-off instruction by operations of a user, the delay circuit cuts off a connection between the power supply and the processor, and further outputs a record signal and a working voltage; the working voltage is applied to support the processor to delay executing the power-off instruction and record a current position of a playing video file in the storage in response to the record signal; the delay circuit further stops outputting the working voltage after the processor finishes executing the power-off instruction.

2. The electronic device of claim 1, wherein the delay circuit comprises a delay module and an operation module connected between the power supply and the delay module; the operation module disconnects the delay module with the power supply when receiving the power-off instruction and generates the record signal; the delay module outputs the working voltage when disconnecting with the power supply and stops outputting the working voltage after a predetermined interval; the processor is powered on by the working voltage and records a current position of a playing video file in the storage in response to the record signal.

3. The electronic device of claim 1, wherein the predetermined interval is adjustable.

4. The electronic device of claim 3, wherein the delay module comprises a capacitor, a first resistor, and a second resistor; a first terminal of the capacitor is connected to the operation module, a second terminal of the capacitor is grounded, a first terminal of the second resistor is connected to the operation module; a second terminal of the second resistor is grounded.

5. The electronic device of claim 3, wherein the delay circuit further comprises a triggering module; the triggering module connects between the processor and the delay module; the processor further generates a triggering signal when finishing recording the current position; the triggering module controls the delay module to stop outputting the working voltage in response to the triggering signal.

6. The electronic device of claim 5, wherein the triggering module comprises a transistor and a third resistor; a base of the transistor is connected to the processor; an emitter of the transistor is grounded, a collector of the transistor is connected to the delay module through the third resistor.

7. The electronic device of claim 6, wherein the transistor is an npn type bipolar junction transistor.

8. A delay circuit connected between a power supply and a processor; the delay circuit comprising:
an operation module connected between the power supply and the delay module; and
a delay module connected to the processor;
wherein the operation module cuts off the connection between the power supply and the delay module when receiving a power-off instruction and generates a record signal; the delay module outputs a working voltage when disconnecting with the power supply; the working voltage is applied to support the processor to delay executing the power-off instruction and record a current position of a playing video file in response to the record signal.

9. The delay circuit of claim 8, wherein the delay module stops outputting the working voltage after a predetermined interval and the predetermined interval is adjustable.

10. The delay circuit of claim 8, wherein the delay module comprises a capacitor, a first resistor, and a second resistor; a terminal of the capacitor is connected to the operation module, an opposite terminal of the capacitor is grounded, a terminal of the second resistor is connected to the operation module; an opposite terminal of the second resistor is grounded.

11. The delay circuit of claim 8, wherein the delay circuit further comprises a triggering module; the triggering module connects between the processor and the delay module; the processor further generates a triggering signal when finishing recording the current position; the triggering module controls the delay module to stop outputting the working voltage in response to the triggering signal.

12. The delay circuit of claim 11, wherein the triggering module includes a transistor and a third resistor; a base of the transistor is connected to the processor; an emitter of the transistor is grounded, a collector of the transistor is connected to the delay module through the third resistor.
